(19) United States
(12) Patent Application Publication
(10) Pub. No.: US 2011/0103864 A1
(43) Pub. Date: May 5, 2011

(54) BRAILLE PRINTING DEVICE

(75) Inventors: Shaopeng Guo, Beijing (CN); Junbiao Liu, Beijing (CN); Li Han, Beijing (CN); Luning Xu, Beijing (CN)

(73) Assignee: Institute of Electrical Engineering Chinese Academy of Sciences, Beijing (CN)

(21) Appl. No.: 13/000,646

(22) PCT Filed: Sep. 27, 2009
(86) PCT No.: PCT/CN2009/074244

§ 371 Date: Jan. 13, 2011

(30) Foreign Application Priority Data
Apr. 24, 2009 (CN) 200910082584.0

(51) Int. Cl. B41J 3/32

(52) U.S. Cl. 400/109.1

(57) ABSTRACT

A braille printing device is disclosed. The device comprises a paper picking-up mechanism, a paper feeding mechanism, a printing mechanism, a curing light source (8) and a paper discharging mechanism. The paper picking-up mechanism, the printing mechanism, the curing light source and the paper discharging mechanism are arranged above a base (6) in turn. The paper feeding mechanism is installed in an X-direction guide on the base (6) and moves to and fro along the X-direction guide under the paper picking-up mechanism, the printing mechanism, the curing light source (8) and the paper discharging mechanism. The printing mechanism is fixed to two posts (16) at two sides of the middle of the base (6). The curing light source (8) and a glue jet valve (10) of the printing mechanism are disposed at two sides of the posts (16) respectively. Electromagnetic clamps (7) of the paper discharging mechanism are mounted at the end of the base (6). The device can simultaneously perform printing and curing operations.

This application claims the benefit of Chinese patent application No. 200910082584.0, titled “Braille Printing Device” and filed with the Chinese Patent Office on Apr. 24, 2009, which is herein incorporated by reference in its entirety.

### FIELD OF THE INVENTION

The present invention relates to a Braille printing device, and in particular, to a Braille printing device for printing Braille text using an adhesive spraying-based method.

### BACKGROUND OF THE INVENTION

Conventional Braille printing normally needs kraft paper, which is expensive and has relatively high hardness and strength. Braille printers or embossers produce a deformation in the surface of the kraft paper to form a raised or recessed Braille dot by a mechanical impact, press, etc. This method requires kraft paper with certain hardness and strength, which is expensive and results in high-priced Braille prints.

Japanese patent application JP 2000-354805A disclosed a Braille forming apparatus using a light-curable polymer material. As illustrated in FIG. 6, the patent application showed that prescribed Braille dots can be formed by spraying a liquid polymer material that is curable in visible light through relative movements between a paper holding table and a nozzle. The Braille forming apparatus disclosed by the patent application is flawed in its lack of paper feeding, paper pickup and paper discharging functions.

Conventional UV inkjet printers provide large-format printing. Their paper feeding mechanism includes multiple pairs of paper feeding rollers grabbing a piece of paper, and feeding the paper with pivot friction. These printers are not devices in the field of Braille printing and can not be used directly for producing Braille prints.

Technically, their roller-based paper feeding and paper discharging mechanisms can not be used for printing Braille text with raised dots. And the ink used has a low adhesiveness, which produces a thin (less than 0.1 mm) film, therefore can not be used in Braille printing.

### SUMMARY OF THE INVENTION

An object of the present invention is to overcome the drawbacks of the existing inkjet printers that they can not be used to print Braille prints, and to provide a simple-structured, complete-functioned and fully automated Braille printing device, so as to significantly improve speed and quality of Braille printing.

The Braille printing device provided by the present invention includes a paper pickup section, a paper feeding section, a printing section, a curing light source and a paper discharging section. In cooperation, the five sections above can realize high-speed Braille printing (dot spraying). The paper pickup section, the printing section, the curing light source and the paper discharging section are mounted over a base sequentially. The paper pickup section is mounted at an end of the base, and is fixed on the base by a support. A paper discharging electromagnet clamp forming the paper discharging section is mounted at the other end of the base. An X-directional guide is mounted within the base, and the paper feeding section is mounted in the X-directional guide within the base and movable in the X-directional guide. The paper feeding section is movable back and forth below the paper pickup section, the printing section, the curing light source and the paper discharging section. The printing section is fixed to two posts at the two sides of a middle part of the base. Two ends of the curing light source are fixed on sidewalls of the two posts. The curing light source and an adhesive spraying valve of the printing section are situated on the two sides of the posts, respectively.

An upper part of the paper pickup section is an input paper tray, a lower part of it is an output guiding track, and a middle part of it is its key component: a paper pickup assembly. The guiding track is a slideway flanged at two sides, has a width slightly wider than a page of printing paper, and has a bottom slightly higher than a paper holding plate.

The paper feeding section includes a paper feeding motor, the X-directional guide, a threaded rod, a slider driving section and its key component: the paper holding plate. The long threaded rod is provided in the guide, a slider is mounted in the guide, and the threaded rod penetrates through the slider, which is a nut. The paper feeding motor is mounted on an end of the guide, a shaft of the paper feeding motor is fixed to the threaded rod, and the paper feeding motor is adapted to move the threaded rod and to drive the slider (nut) to move along the guide. The paper holding plate is fixed to the slider in the horizontal guide via a connector, and is movable along with the slider. The X-directional guide is fixed on the base. An exiting direction of the paper pickup section is parallel to the direction of the X-directional guide. The paper pickup section is above the paper feeding section. A paper pickup electromagnet clamp and a photoelectric detector are mounted on the two sides of a rear part of the paper holding plate. Following the slider, the paper holding plate is movable to a lower exit of the paper pickup section, where paper picked up by the paper pickup section is delivered to the paper holding plate. The two sides of the paper pass the paper pickup electromagnet clamp and the photoelectric detector, and are detectable by the photoelectric detector. The paper pickup electromagnet clamp is adapted to grab the paper.

When the photoelectric detector detects the paper delivered by the paper pickup assembly of the paper pickup section, the paper pickup electromagnet clamp is turned on and grabs the paper, then the paper feeding motor drives the slider and the paper holding plate to move in the X direction, thereby realizing paper feeding function.

The printing section is mounted at the middle part of the base. The printing section includes a printing motor, a Y-directional guide and the adhesive spraying valve mounted on a slider of the guide. The two vertical posts are mounted on the two sides of the middle part of the base, and two ends of the Y-directional guide of the printing section are fixed to the posts. The printing motor is mounted on an end of the

Y-directional guide. The adhesive spraying valve is fixed to the slider of the Y-directional guide, the adhesive spraying valve is mounted on the left side of the posts, and the nozzle of the adhesive spraying valve points downwards to the paper holding plate. The printing motor is adapted to move a threaded rod to drive the slider and the adhesive spraying valve to move back and forth along the Y-directional guide. The adhesive spraying valve is adapted to spray a line of Braille dots through each of its one-way movements in the Y direction, and two lines of Braille dots through each of its back-and-forth movements. The Y-directional guide is perpendicular to the direction of the X-directional guide of the paper feeding section mounted on the base. Each time the adhesive spraying valve finishes spraying a line of Braille dots in the Y direction, the paper holding plate of the paper feeding section advances paper feeding by one line, and the adhesive spraying in the Y direction and paper feeding in the X direction alternate at the adhesive spraying stage.

The curing light source is fixed on the right side of the two posts via a connector. The paper holding plate passes below the adhesive spraying valve and the curing light source sequentially. The curing light source is close to the adhesive spraying valve, enabling adhesive spraying and curing at the same time, thereby improving print production efficiency and reducing the size of the device as a whole.

The paper discharging section, i.e., the paper discharging electromagnet clamp, is mounted at the other end of the base. It is on the same horizontal level as the paper holding plate. Paper is carried by the paper holding plate to the paper discharging electromagnet clamp after printed by the adhesive spraying valve and cured by the curing light source. The paper on the paper holding plate enters an opening of the paper discharging electromagnet clamp horizontally.

The paper pickup electromagnet clamp and the paper discharging electromagnet clamp are made based on electromagnets. An electromagnet includes a sliding lever, a coil with many turns of wire, and a restoring spring. The sliding lever is ferromagnetic, and penetrates through the center of the coil. The sliding lever is adapted to move in an axial direction of the sliding lever while turned on, and to return under the restoring spring while turned off. An end of the sliding lever has a bar, which is a small sheet of metal or plastic, chamfered to facilitate entry of the paper. When the electromagnet is turned on or turned off, the sliding lever drives the bar to move, and the bar secures or releases the paper under, thereby realizing paper grabbing and releasing functions.

Paper feeding mechanism of the present invention is based on a flat plate bearing paper, and can be used in producing raised Braille dots. The invention can perform paper pickup, paper feeding, printing, curing and paper discharging functions with common printing paper (e.g. A4 printing paper) directly, and print out Braille prints with highly raised Braille dots.

### BRIEF DESCRIPTION OF THE DRAWINGS

The invention is described hereinafter in connection with the accompanying drawings and embodiments.

FIG. 1 is a structural diagram of a device according to the invention, in which: 1 paper tray, 2 paper pickup assembly, 3 guiding track, 4 paper holding plate, 5 paper pickup electromagnet clamp, 6 base, 7 paper discharging electromagnet clamp, 8 curing light source, 9 Y-directional guide, 10 adhesive spraying valve, 11 paper feeding motor, 13 photoelectric detector, and 16 post.

FIG. 2 is a main view illustrating a structural relationship between the base and the paper holding plate according to the invention.

FIG. 3 is a top view illustrating a structural relationship between the base and the paper holding plate according to the invention, in which: 14 paper discharging opening, and 15 slider.

FIG. 4 is a flow chart of operating of a printer;

FIG. 5 is a diagram illustrating a pulse train of Braille spraying; and

FIG. 6 is a figure from JP 2000-354805A.

### DETAILED DESCRIPTION OF THE EMBODIMENTS

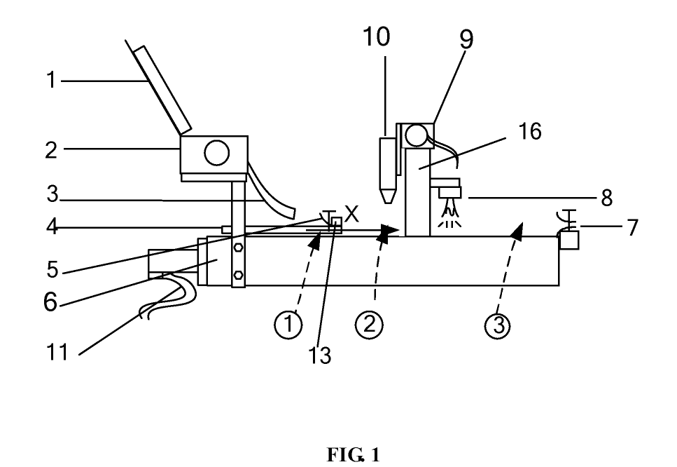

As shown in FIG. 1, the Braille printing device provided by the invention includes a paper pickup section, a paper feeding section, a printing section, a curing light source and a paper discharging section. The paper pickup section, the printing section, the curing light source and the paper discharging section are mounted over a base 6 in the order as presented above. An X-directional guide is mounted within the base 6, and the paper feeding section is mounted in the X-directional guide within the base 6 and movable in the X-directional guide. The paper pickup section is mounted over an end of the base 6 via a support, two posts 16 put up a Y-directional guide of the printing section in a middle part of the base 6, and two ends of the curing light source 8 are fixed on sidewalls of the two posts 16 via a support, respectively. The paper discharging section is mounted at the other end of the base 6. The paper feeding section is movable back and forth below the paper pickup section, the printing section, the curing light source and the paper discharging section.

The paper pickup section is mounted at a front part of the base 6, and is fixed on the base 6 via the support. The paper pickup section includes an upper-part paper tray 1 for inputting paper, a lower-part guiding track 3 for outputting paper and a middle-part paper pickup assembly 2. The paper pickup section may be a paper pickup assembly capable of implementing paper pickup function, or a common printer also having printing function. In this embodiment, an existing printer is used as the paper pickup section. The printer is fixed to the base 6 using the support and lifted to a certain height. The paper tray 1 that comes with the printer is used for storing printing paper. A guiding track 3 is mounted at a lower exit of the paper pickup section. The guiding track 3 is a slideway flanged at two sides, and has a width slightly wider than a page of the printing paper. The guiding track 3 is fixed to a paper exit of the printer. The guiding track 3 is capable of directing the paper pushed out from the paper pickup assembly 2. The bottom of the guiding track 3 is slightly higher than a paper holding plate 4, and the guiding track 3 is not in the way of horizontal movements of the paper holding plate 4. Once a paper delivering button of the printer is triggered, a piece of paper is picked up from the paper tray 1 and is directly pushed out without printing. If it is desired to print visible text and have a mixed document with both Braille and visible text in the end, visible text printing may be performed at this stage. Whether or not visible text printing is needed, the paper pickup assembly 2 always picks up a piece of paper from the paper tray 1 and takes it to the guiding track 3. The directing feature of the guiding track 3 can get the front of the paper transferred downwards by the paper pickup assembly 2 (or, the printer) enter the opening of the paper pickup electromagnet clamp 5 on the paper holding plate 4.

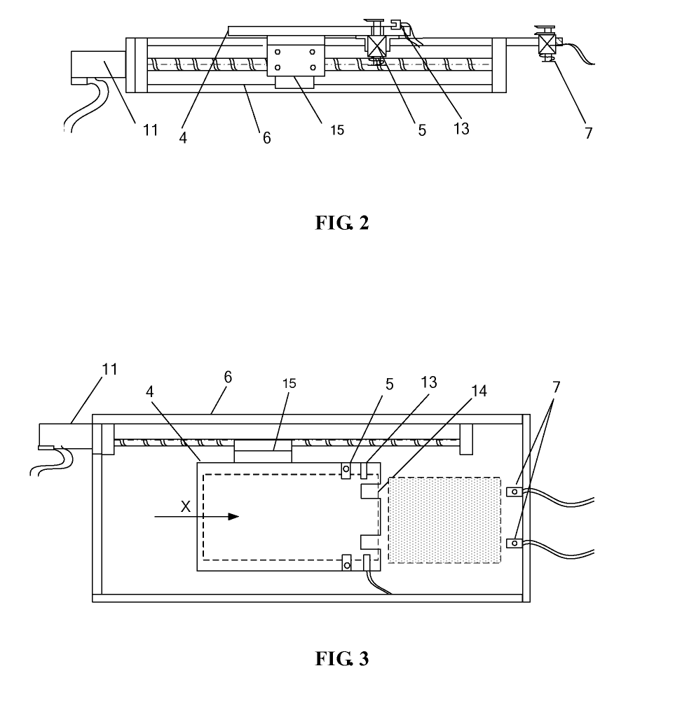

A shown in FIGS. 2 and 3, the base 6 has a rectangular frame structure, with the X-directional guide, a threaded rod and a paper feeding motor 11 mounted on one side of it. The paper holding plate 4 is fixed to a slider 15 in the Y-directional guide, and two paper pickup electromagnet clamps 5 and two photoelectric detectors 13 are mounted on the paper holding plate 4. Two paper discharging openings 14 are formed on an edge of the paper holding plate 4 towards the paper discharging electromagnet clamp 7.

The function of the paper feeding section is to grab obtained paper and to deliver it to a position desired for printing. The paper feeding section uses a plat plate-based paper feeding method, and has a structure as shown in FIGS. 2 and 3. A key component of the paper feeding section is the paper holding plate 4. The paper holding plate 4 is slightly larger than the printing paper (e.g. standard A4). The paper holding plate 4 is fixed to a slider 15 of the X-directional guide via a connector. The X-directional guide is fixed on one side of the base 6 within it. The paper feeding motor 11 is mounted with the X-directional guide, and a threaded rod is mounted in the X-directional guide. The paper feeding motor 11 drives the slider 15 and the paper holding plate 4 to move by rotation of the threaded rod. Two paper pickup electromagnet clamps 5 and two photoelectric detectors 13 are mounted on the two sides of a rear part of the paper holding plate 4. The paper pickup assembly 2 of the paper pickup section is above the paper holding plate 4. As for paper delivered from the paper pickup assembly 4, the paper pickup electromagnet clamp 5 is before the photoelectric detector 13, in the delivering direction of the paper. The distance between the two paper pickup electromagnet clamps 5 is consistent with the paper width. Once pushed in by the paper pickup assembly 2, the two sides of paper pass the openings of the two paper pickup electromagnet clamps 5 and the two photoelectric detectors 13. When the photoelectric detector 13 detects the paper, the paper pickup electromagnet clamp is turned on and grabs the paper, then the paper feeding motor 11 drives the threaded rod to rotate and the slider 15, i.e., a nut, to move along the X-directional guide.

The printing section is mounted at a middle part of the base 6. The printing section includes a printing motor, the Y-directional guide 9, and an adhesive spraying valve 10 mounted on the slider of the Y-directional guide. Two ends of the Y-directional guide 9 of the printing section are fixed to the posts 16. The printing motor is mounted on an end of the Y-directional guide 9 of the printing section. The adhesive spraying valve 10 is fixed to the slider of the Y-directional guide, and the nozzle of the adhesive spraying valve 10 points downwards to the paper holding plate 4. The printing motor drives the slider and the adhesive spraying valve 10 to move back and forth along the

Y-directional guide by rotation of a threaded rod. The Y-directional guide is perpendicular to the direction of the X-directional guide of the paper feeding section mounted on the base.

Printing is implemented mainly by the adhesive spraying valve 10 scanning and spraying along the Y-directional guide 9. The sprayed adhesive may be a curable adhesive with a high adhesiveness larger than 2000, e.g., an ultraviolet (UV) adhesive (OG154), and the resulting Braille dot may have a volume ranging from 0.3 uL to 1 uL and a height larger than 0.3 mm. Under a controlling pulse, each of the one-way movements of the adhesive spraying valve 10 may produce a line of Braille dots. The adhesive spraying valve 10 may be a high-speed piezoelectric adhesive spraying valve, e.g., 744MV-100 from the EFD. The adhesive spraying valve can spray a Braille dot within 2 milliseconds, and has a rated dot spraying frequency of 150 Hz. For A4 printing paper, the number of dots in one line is within 60, thus a line of Braille dots can be sprayed within 0.5 seconds. In order to print a line of Braille dots, it is only needed to send a spraying pulse sequence by a controller according to the content of a document to be printed. As shown in FIG. 5, the controlling pulses applied to the adhesive spraying valve have a one-to-one correspondence to the Braille dots to be printed. The adhesive spraying valve 10 moves back and forth along the Y-directional guide 9 while spraying Braille dots. Each time the adhesive spraying valve 10 finishes spraying a line of Braille dots in the Y direction, the paper holding plate 4 of the paper feeding section advances by a line spacing in the X direction. With the line-by-line scanning and spraying, a whole page of Braille dots can be sprayed.

The two ends of the curing light source 8 are fixed on sidewalls of the two posts 16 respectively. The paper holding plate 4 passes below the curing light source 8. The curing light source 8 is a row of UV LEDs, the total width of which is consistent with the width of the printing paper. The light emitting face of the LED is directed downwards to the paper holding plate 4, with a distance from the paper holding plate 4 being 1 centimeter. The UV LED can soon solidify the liquid UV curable adhesive to a solid.

The curing light source 8 and the adhesive spraying valve 10 are situated on the two sides of the post 16, respectively. In the printing by the adhesive spraying valve 10, paper is continuously sprayed with Braille dots line-by-line, and the paper holding plate 4 continuously advances in the X direction. Sprayed areas gradually enter below the curing light source 8, and pass the irradiation area of the curing light source 8. This “printing while curing” manner may increase the speed of the whole process, and improve print production efficiency. Moreover, the arrangement of LEDs reduces the length of the device as a whole in the X direction, and reduces the size of the device as a whole. The reason that curing light source 8 uses the UV LEDs is: in order to improve printing speed, the UV has to have a high light intensity, however, conventional UV high-pressure mercury lamps are high powered and have severe heat generation problems, which is damaging to the paper; moreover, common fluorescent lamps are small in their UV power densities and need a long time for curing, which inevitably leads to increased mechanical size of the curing process if they are used in the high-speed printing above. The UV LEDs have a high lighting efficiency and generate a small amount of heat, therefore the invention uses multiple UV LEDs arranged in a row in the direction of spraying, what is more, the row of UV LEDs are situated close to the adhesive spraying valve 10 in the X direction, so that adhesive dots can enter the curing area as soon as possible once sprayed. Advantageous effects include improved quality of the dots, increased page printing speed and reduced length of the device as a whole. If the curing result with one row of LEDs is not satisfying, tow or more rows of LEDs may be used.

The paper discharging section, i.e., the paper discharging electromagnet clamp 7, is mounted at the tail end of the base. It is on the same horizontal level as the paper holding plate 4. Paper is held from below by the paper holding plate 4, to the paper discharging electromagnet clamp 10, after printed by the adhesive spraying valve 10 and cured by the curing light source 8. The upper surface of the paper holding plate 4 is at the same height as the opening of the paper discharging electromagnet clamp 7. A paper discharging opening 14 is formed on the paper holding plate 4, and the paper discharging electromagnet clamp can enter the paper discharging opening 14. Then, the paper on the paper holding plate can enter the opening 14 of the paper discharging electromagnet clamp horizontally.

The paper pickup electromagnet clamp 5 and the paper discharging electromagnet clamp 7 are made based on electromagnets. The electromagnet includes a sliding lever, a coil with many turns of wire, and a restoring spring. The sliding lever is ferromagnetic, and penetrates through the center of the coil. The sliding lever moves in an axial direction of the sliding lever while turned on, and returns under the restoring spring while turned off. An end of the sliding lever has a bar, which is a small sheet of metal or plastic, chamfered to facilitate entry of the paper. When the electromagnet is turned on or turned off, the sliding lever drives the bar to move, and the bar secures or releases the paper under, thereby realizing paper grabbing and releasing functions.

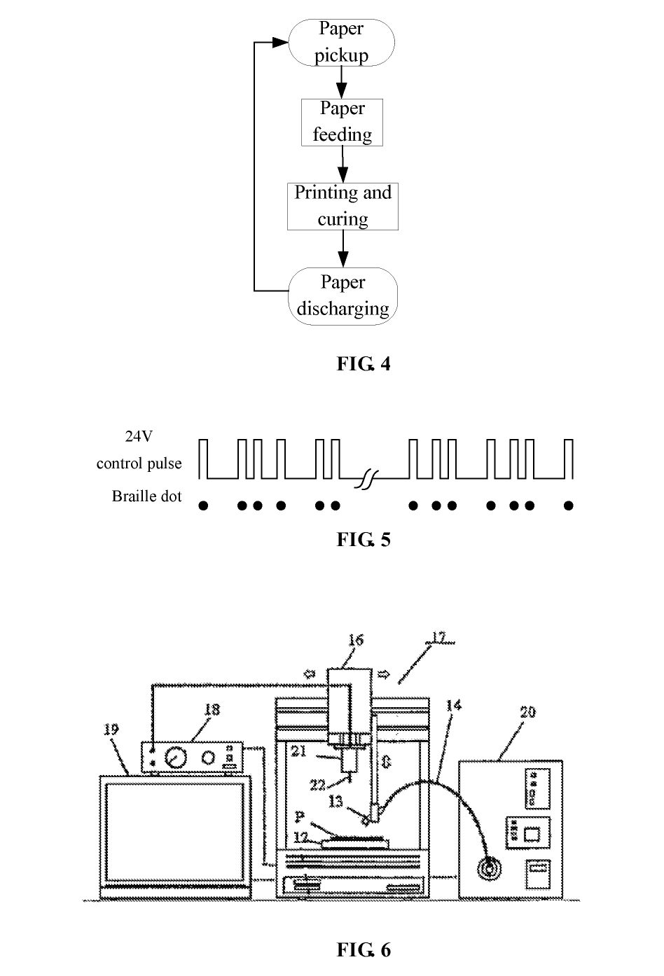

A flow chart of the operating of the invention is as shown in FIG. 4, including paper pickup, paper feeding, printing and curing, and paper discharging performed in the order as presented. The set of operations is executed under the control of a computer or other controllers.

Paper in the paper tray 1 may be picked up automatically, and transferred downwards to the paper holding plate 4 of the paper feeding section. The photoelectric detector 13 of the paper holding plate may detect whether the paper is in place. Once in place, the paper is automatically moved under the adhesive spraying valve 10 of the printing section. The adhesive spraying valve 10 prints line-by-line, and the curing light source 8 cures the sprayed Braille dots sequentially. After printing, the paper holding plate 4 reaches the paper discharging electromagnet clamp 7, the paper discharging electromagnet clamp 7 removes the paper, the paper holding plate 4 returns to the paper pickup position, and the next operation cycle is entered automatically. In an operation cycle, the process from the paper tray to the outputting of final prints is fully automated, and full automation is realized.

Paper pickup: as shown in FIG. 1, paper pickup is the process of picking up printing paper in the paper tray 1 in pieces and delivering it to the paper holding plate 4. First the paper holding plate 4 returns to position □, then the paper pickup assembly 2 (a common printer) picks up a piece of paper from the paper stack in the paper tray 1, prints visible text on it or directly transfers it to the guiding track 3. Pushed by the paper pickup assembly 2 (the common printer), the paper smoothly enters the paper holding plate 4 via the guiding track 3. Directed by the guiding track 3, the front edge of the paper enters the paper pickup electromagnet clamp 5. When the photoelectric detector detects the paper, the paper pickup electromagnet clamp 5 is turned on and grabs the paper.

Paper feeding: after the process of paper pickup, most of the piece of paper remains in the guiding track 3, but the paper is grabbed tightly by the paper pickup electromagnet clamp 5. Then, the paper holding plate 4 is moved by the paper feeding motor 11 to below the adhesive spraying valve 10 along the X-directional guide 6, so that the paper is delivered to a position directly below the adhesive spraying valve 10 (e.g., position □ shown in FIG. 1) for printing.

Printing: the printing and curing are performed at the same time in cooperation of X-directional movements of the paper feeding section and movements of the adhesive spraying valve 10 along the Y-directional guide 9. In the process of printing, the adhesive spraying valve 10 moves back and forth along the Y-directional guide only. Under a controlling pulse, each of the one-way movements of the adhesive spraying valve 10 may produce a line of Braille dots. Following each of the one-way movements, the paper holding plate 4 moves the paper forwards by a line spacing in the X direction.

With the alternating adhesive spraying in the Y direction and paper feeding in the X direction, a whole page of Braille dots can be sprayed line-by-line. Spraying of the adhesive spraying valve 10 is performed in both back and forth directions, therefore each of the back-and-forth movements produces two lines of Braille.

Curing: curing is the process of solidifying Braille dots sprayed by the adhesive spraying valve in the process of printing to solids. The process of curing is not performed only when printing is completely finished. The curing light source 8, i.e., the UV LED, is close to the adhesive spraying valve. While the adhesive spraying valve 10 is spraying line-by-line, the paper feeding section continuously pushes the paper holding plate 4 forward in the X direction. When a part of the paper holding plate 4 enters below the curing light source 8, the process of curing is started. Curing of the curing light source 8 and spraying of the adhesive spraying valve 10 are performed at the same time. When the adhesive spraying valve 10 finishes printing, the paper holding plate 4 continues to move in the X direction, and the process of curing is finished only until a whole page of Braille dots are cured.

Paper discharging: when printing is finished and curing is completed, the paper holding plate 4 delivers the paper to position □ shown in FIG. 1. The front edge of the paper enters the opening of the paper discharging electromagnet clamp 7. The paper discharging electromagnet clamp 7 is turned on and grabs the paper. Meanwhile, the paper pickup electromagnet clamp 5 is turned off and releases the paper. The paper holding plate 4 moves from position \textcircled{3} to position □, and the paper stays at position \textcircled{3}as being grabbed by the paper discharging electromagnet clamp 7. When the paper holding plate 4 returns to position □ shown in FIG. 1, the paper is completely discharged from the paper holding plate 4, the paper discharging electromagnet clamp 7 is turned off and separated, and the paper falls down due to gravity.

Through the five operation processes above, a whole operation cycle is completed, and the next cycle for Braille printing can be entered.

1. A Braille printing device, comprising a paper pickup section, a paper feeding section, a printing section, a curing light source and a paper discharging section, wherein:
the paper pickup section, the printing section, the curing light source and the paper discharging section are mounted over a base sequentially;
the paper pickup section is mounted at an end of the base, and a paper discharging electromagnet clamp forming the paper discharging section is mounted at the other end of the base;
an X-directional guide is mounted within the base, and the paper feeding section is mounted in the X-directional guide within the base and is movable in the X-directional guide;
the paper feeding section is movable back and forth below the paper pickup section, the printing section, the curing light source and the paper discharging section;
the printing section is fixed to two posts at the two sides of a middle part of the base;
two ends of the curing light source are fixed on sidewalls of the two posts;
the curing light source and an adhesive spraying valve of the printing section are situated on the two sides of the posts, respectively.

2. The Braille printing device according to claim 1, wherein: a guiding track is mounted at a lower exit of the paper pickup section, the guiding track is a slideway flanged at two sides, has a width slightly wider than a page of printing paper and has a bottom slightly higher than a paper holding plate.

3. The Braille printing device according to claim 1, wherein:
a paper holding plate of the paper feeding section is fixed to a slider of the X-directional guide within the base;
a paper feeding motor, a threaded rod and the slider are mounted with the X-directional guide;
the paper feeding motor is adapted to drive the slider and the paper holding plate to move by rotation of the threaded rod;
two paper pickup electromagnet clamps and two photoelectric detectors are mounted on the two sides of a rear part of the paper holding plate.

4. The Braille printing device according to claim 3, wherein: when the photoelectric detector detects paper delivered by a paper pickup assembly of the paper pickup section, the paper pickup electromagnet clamp is turned on and grabs the paper, and the paper feeding motor drives the slider and the paper holding plate to move in the X direction, thereby realizing paper feeding function.

5. The Braille printing device according to claim 1, wherein:
the adhesive spraying valve is mounted on a slider of a Y-directional guide of the printing section;
a nozzle of the adhesive spraying valve points downwards to the paper holding plate;
the adhesive spraying valve is movable along the Y-directional guide, and the direction of the movement of the adhesive spraying valve is perpendicular to the direction of the X-directional guide of the paper feeding section mounted on the base.

6. The Braille printing device according to claim 5, wherein:
the curing light source comprises a plurality of ultraviolet Light-Emitting Diodes, UV LEDs, arranged in one row or a plurality of rows;
a total width of the UV LEDs equals to a width of printing paper;
light emitting faces of the LEDs are directed to the paper holding plate.

7. The Braille printing device according to claim 1, wherein:
the paper discharging electromagnet clamp and the paper pickup electromagnet clamp of a paper holding plate are made based on electromagnets;
when the paper discharging electromagnet clamp grabs paper and the paper pickup electromagnet clamp on the paper holding plate releases the paper, the paper holding plate is moved away from the paper discharging electromagnet clamp, the paper is pulled out by the paper discharging electromagnet clamp from the paper holding plate, then the paper discharging electromagnet clamp releases the paper, and the paper falls down due to gravity, thereby realizing paper discharging function.

8. The Braille printing device according to claim 3, wherein:
the paper discharging electromagnet clamp and the paper pickup electromagnet clamp of a paper holding plate are made based on electromagnets;
when the paper discharging electromagnet clamp grabs paper and the paper pickup electromagnet clamp on the paper holding plate releases the paper, the paper holding plate is moved away from the paper discharging electromagnet clamp, the paper is pulled out by the paper discharging electromagnet clamp from the paper holding plate, then the paper discharging electromagnet clamp releases the paper, and the paper falls down due to gravity, thereby realizing paper discharging function.
